(19) United States
(12) Patent Application Publication
(10) Pub. No.: US 2020/0137845 A1
(43) Pub. Date: Apr. 30, 2020

(54) Frequency-Adjustable Lamp with Stand

(71) Applicant: Verilux, Inc., Waitsfield, VT (US)

(72) Inventor: Nicholas Harmon, Waitsfield, VT (US)

(21) Appl. No.: 16/414,187

(22) Filed: May 16, 2019

Related U.S. Application Data
(63) Continuation-in-part of application No. 16/169,401, filed on Oct. 24, 2018.

(51) Int. Cl. H05B 33/08; F21V 21/06; F21V 21/108; F21V 21/14

(52) U.S. Cl. CPC H05B 33/0845; F21V 21/06; F21Y 2115/10; F21V 21/145; F21V 21/108

(57) ABSTRACT

A lamp having a light source for emitting light, a stand having a plate and a first connector, the lamp having a protrusion and a second connector, the stand being connectable to the lamp in a standing position and in a stowing position, wherein in the standing position, the first connector is connected to the second connector, and wherein in the stowing position, the plate is connected to the protrusion.

### TECHNICAL FIELD

The invention relates to a lamp, including a lamp with a stand, and a healthy lighting lamp.

### BACKGROUND

Sunlight is an essential ingredient for a healthy lifestyle, and many people do not receive enough natural light. Healthy lighting lamps mimic sunlight to enhance mood, energy, sleep, and focus. Healthy lighting lamps have been shown to help with common problems such as winter blues, sleep disorders, light deprivation, jet lag, shift work and other symptoms alleviated by exposure to healthy light. In addition, healthy lighting lamps can help promote brain functionality.

Healthy lighting lamps are often large and bulky due to their size and shape. Since healthy lighting lamps must generally stand up during use, they either must be large enough to support themselves or include a stand. Lamps and stands may be difficult to pack or ship due to their size or shape. This frustrates users who travel with their lamps and increases shipping costs for manufacturers and distributors. Therefore, a more packable healthy lighting lamp is desirable.

In addition, healthy lighting lamps are often limited to one working intensity and color temperature. Since users benefit from being able to select their optimal intensity and/or color temperature, there is a desire for a healthy lighting device that allows such user selection.

Moreover, it is recommended that users of healthy lighting lamps do so for approximately 20 minutes. Therefore, there is a need for healthy lighting lamps that shut off automatically or alert the user when this (or another) recommended amount of time has been reached.

Furthermore, healthy lighting lamps are often limited to outputting light at a single, standard frequency. Therefore, there is a need for a healthy lighting lamp that can output light at variable or non-standard frequencies.

Finally, current healthy lighting lamps use custom light bulbs that are often short-lived and need replacement. There is a need for a longer-lasting full-spectrum light source for healthy lighting lamps.

### SUMMARY

It is an objective of the present invention to provide a more packable or shippable lamp.

It is a further object of the present invention to provide a lamp with multiple selectable and operative light intensities, color temperatures, and light frequencies.

It is a further object of the present invention to provide a lamp with a timer and indicator.

It is a further object of the present invention to provide a lamp with a longer-lasting full-spectrum light source, such as LEDs.

### BRIEF DESCRIPTION OF THE DRAWINGS

FIG. 1 is a perspective view of the inventive lamp.

FIG. 2 is a front view of the inventive lamp.

FIG. 3 is a back perspective view of the inventive lamp.

FIG. 4 is a back view of the inventive lamp with the stand stowed.

FIG. 5 is a back view of the inventive lamp with the stand attached to the bottom of the lamp.

FIG. 6 is a perspective view of the inventive lamp.

FIG. 7 is a front view of the inventive lamp.

FIG. 8 is a back perspective view of the inventive lamp.

FIG. 9 is a back view of the inventive lamp with the stand stowed.

FIG. 10 is a back view of the inventive lamp with the stand attached to the bottom of the lamp.

FIG. 11 is a perspective view of the inventive lamp.

FIG. 12 is a front view of the inventive lamp.

FIG. 13 is a back-perspective view of the inventive lamp.

### DETAILED DESCRIPTION

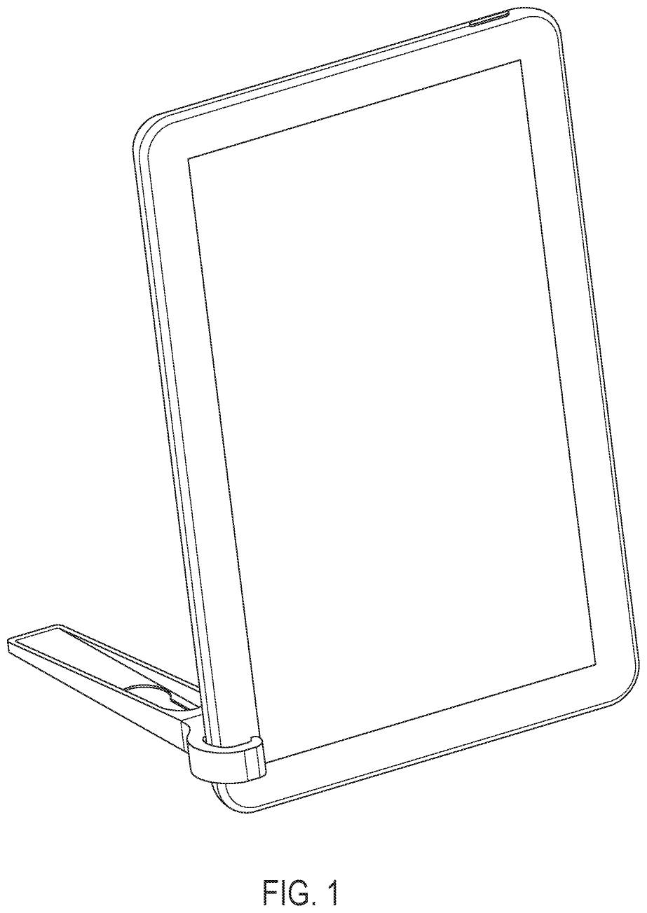

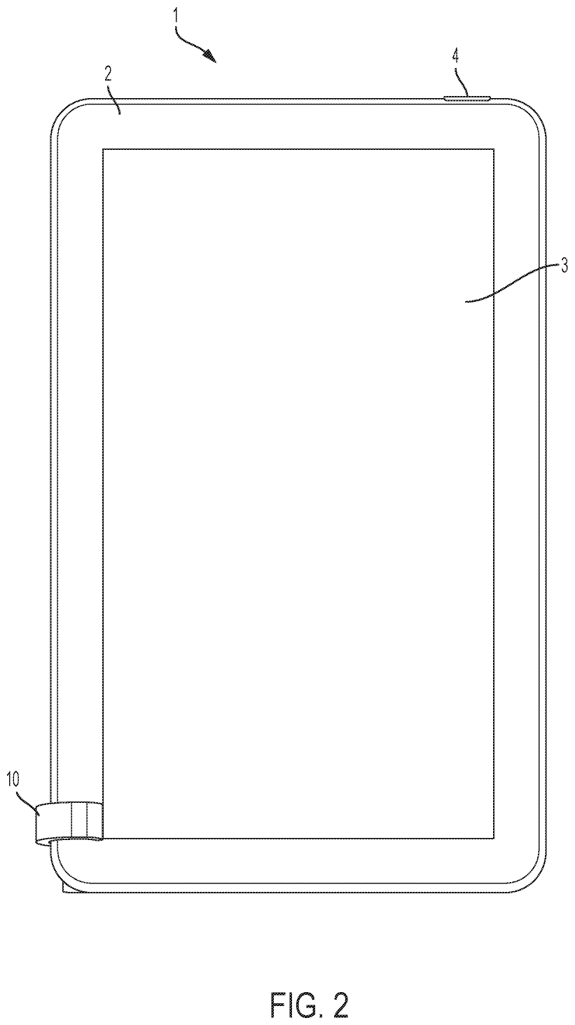

FIGS. 1 and 2 shows lamp 1, that surrounds light emitting surface 3. Stand 10 is attached to lamp 1 for holding it upright during use.

Case 2 surrounds a light emitting surface 3. Button 4 on a surface of case 2 may be used to turn lamp 1 on and off. Case 2 and stand 10 may be made from any suitable material such as a rigid plastic, a metal composite or composition, or combinations thereof. In addition, lamp 1 may comprise any finish and color desired to match an interior design of a workspace.

Lamp 1 may include a countdown timer that changes functionality after a certain amount of time from being turned on. For example, the emitted light may change brightness, color temperature, or frequency buttons after a certain amount of time. In one embodiment, the lamp 1 emits light at 40 Hz when turned on, and after a twenty-minute timer, lamp 1 emits light at a frequency between 20-32 KHz In addition, button 4 may be pressed in such a way that it can control these functionalities, such as with a short-, long-, or multiple press. Such button control of functions is described below with respect to lamps 21 and 41.

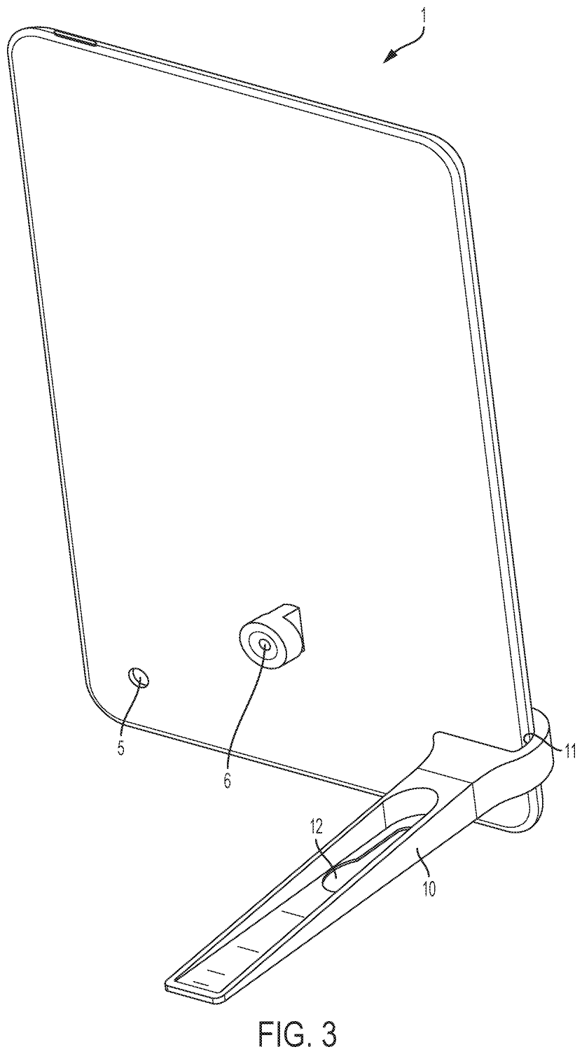

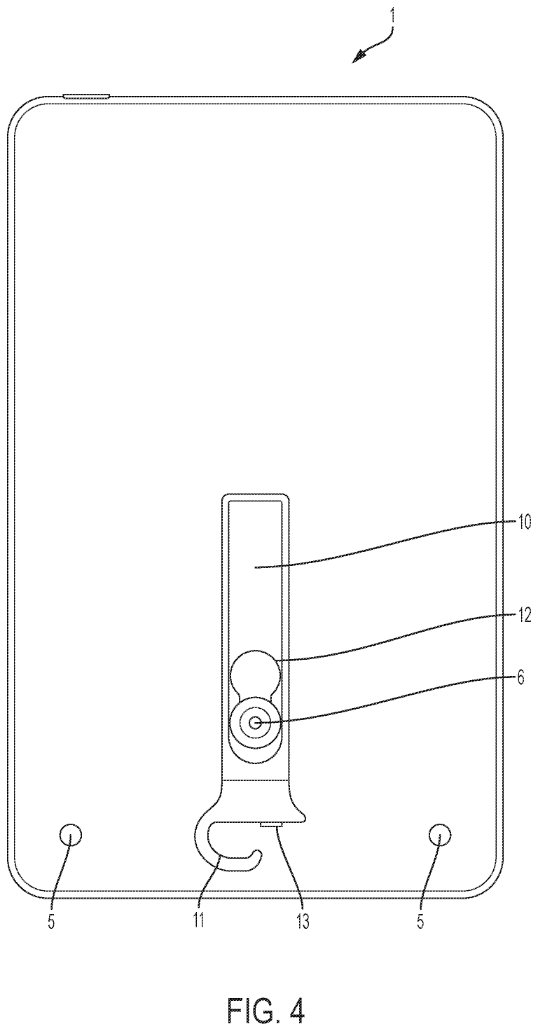

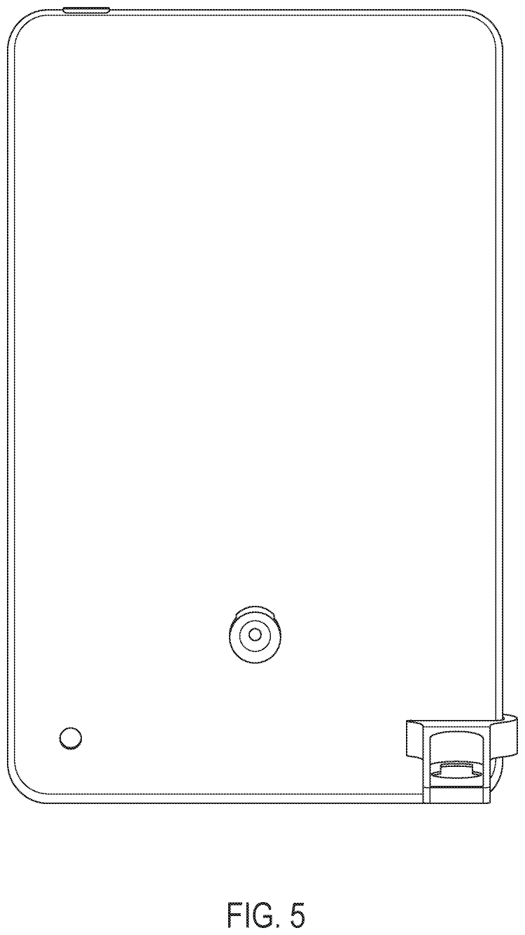

As shown in FIGS. 3-5, stand 10 has a U-shaped clip 11, which is attachable to case 2. When attached to lamp 1, a portion of stand 10, and a side of case 2 keep lamp 1 upright. U-shaped clip 11 may have a bump 13 that extends from its surface to engage with one of multiple depressions 5 in case 2. Bump 13 and depressions 5 help to ensure that U-shaped clip 11 remains in place when holding lamp 1 upright.

U-shaped clip 11 may be attached to case 2 in multiple ways. For example, as shown in FIG. 2, U-shaped clip 11 may be engaged with any depression 5 such that lamp 1 stands in a “portrait” position. Alternatively, stand 10 and U-shaped clip 11 may be positioned such that lamp 1 is in a “landscape” position, rotated approximately 90 degrees from the “portrait” position. U-shaped clip 11 may be attached such the long edge of stand 10, or the short edge of stand 10 is in contact with the surface upon which lamp 1 sits. Stand 10 and case 2 both have multiple, substantially flat sides to enable lamp 1 to sit in multiple configurations.

When lamp 1 is to be shipped, packed or otherwise stowed, stand 10 can be locked on protrusion 6, which extends from a back surface of case 2. Protrusion 6 is and cut-out portion 12 of stand 10 are sized such that they are engageable with one another, as shown in FIG. 3. Stand 10 can then be slid such that cut-out portion 12 and protrusion 6 are locked together. Protrusion 6 may also be configured to connect to a power cable.

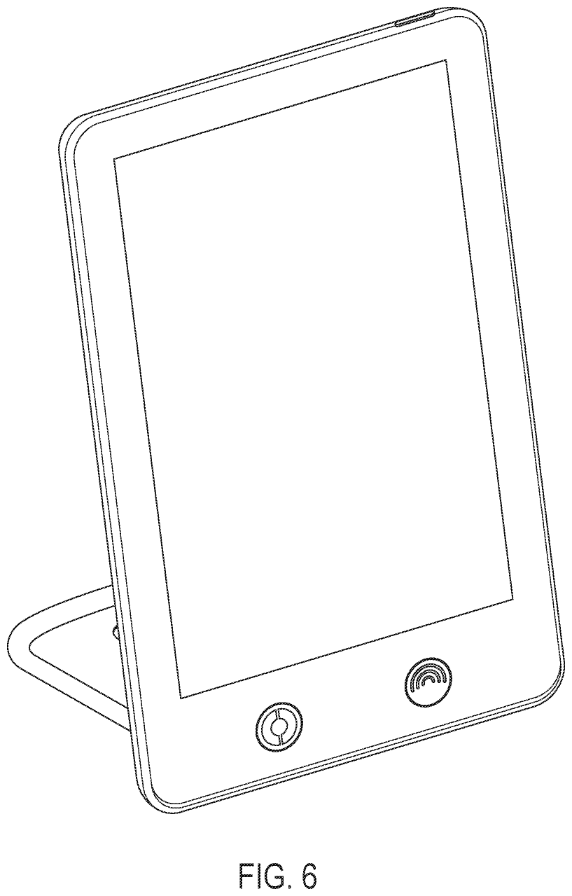

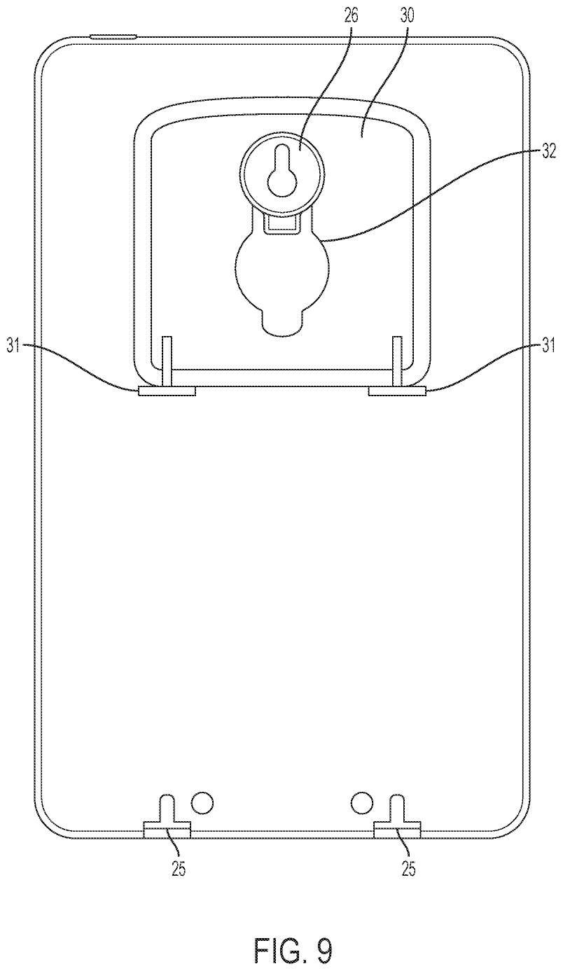

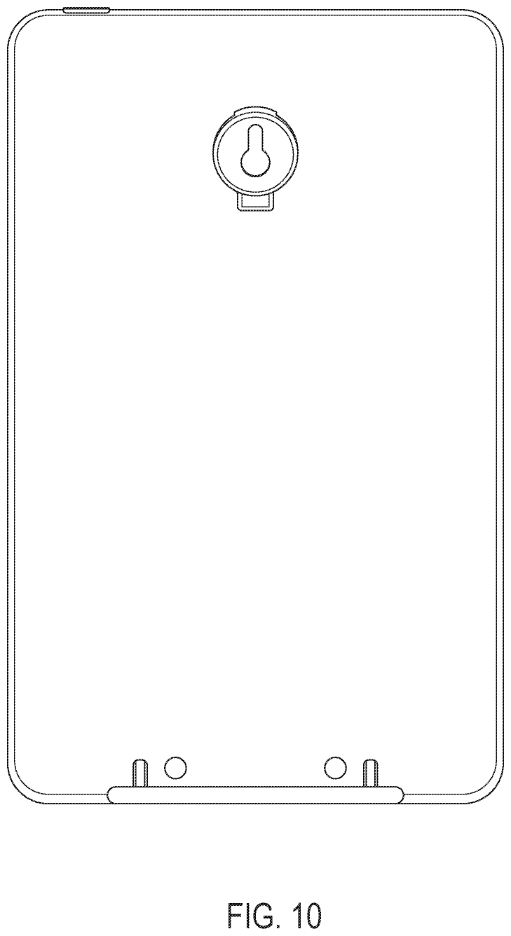

FIGS. 6-10 show lamp 21, with a case 22 that surrounds a light emitting surface 23. Lamp 21 may include a power button 24. Buttons 27 and 28 may also be provided to perform functions of lamp 21. These functions can include, but are not limited to, increasing or decreasing brightness, modifying the emitted light temperature, and setting a usage timer. When pressed, buttons 27 and 28 may cycle through predetermined settings for these functions, or modify the functions at predetermined increments. Lamp 21 may include a controller for effectuating these functions. The controller may include circuitry, including analog and digital circuitry, a computer, including a microprocessor, FGPA, embedded controller, or the like.

For example, buttons 27 or 28 may set lamp 21 to emit light at a brightness of 2,000-15,000 lux at a distance of 4-6 inches. In one preferred embodiment, buttons 27 or 28 may be pressed to cycle emitted light between 2,500, 5,000, 7,500, or 10,000 lux. Buttons 27 or 28 may also set the light temperature of the light emitted from lamp 21 between 3,000 K and 6,500 K. In one preferred embodiment, buttons 27 or 28 may cycle light temperature levels between 3,000 K and 5,000 K in 500 K increments. Buttons 27 or 28 may also set a usage timer for 5, 10, 20, or 30 minutes, after which the lamp may notify the user of the elapsed time, shut off, or both. In one preferred embodiment, the usage time is set for 20 minutes. In another embodiment, the countdown timer may be set in five minute increments up to one hour (sixty minutes). In another embodiment, the countdown timer may be in fifteen minute increments up to one hour (sixty minutes). The values for each of these functions are exemplary, as buttons 27 and 28 may be programmed to set any value associated with any function.

In addition, buttons 27 or 28 may set lamp 21 to emit light at a certain frequency. Standard light bulbs flicker at 100-120 Hz. LED light bulbs have a frequency of between 20 KHz and 32 KHz. Pressing buttons 27 or 28 may cause the light to emit light at different frequencies, including at 2 Hz-60 Hz, 100-120 Hz, or 20-32 KHz. In one embodiment, the frequency of the light is set to 40 Hz. When setting the light frequency to a particular frequency, such as 40 Hz, a usage timer may also be set automatically or using the other of buttons 27 and 28. In one embodiment the usage timer is set for 20 mins, and following its expiration, the frequency of the light is returned to another frequency, such as 100-120 Hz or 20-32 Khz. The light source may also emit light at multiple frequencies.

In some embodiments, lamp 21 may also include an indicator showing a progression of a function. The indicator may be a series of lights or a circular ring that is used to indicate the elapsed or remaining amount of time on a usage timer, the brightness level, the light temperature, or the light frequency. For example, the indicator may show a 20-minute usage timer by illuminating neighboring lights or portions of a circular ring after two-minute increments.

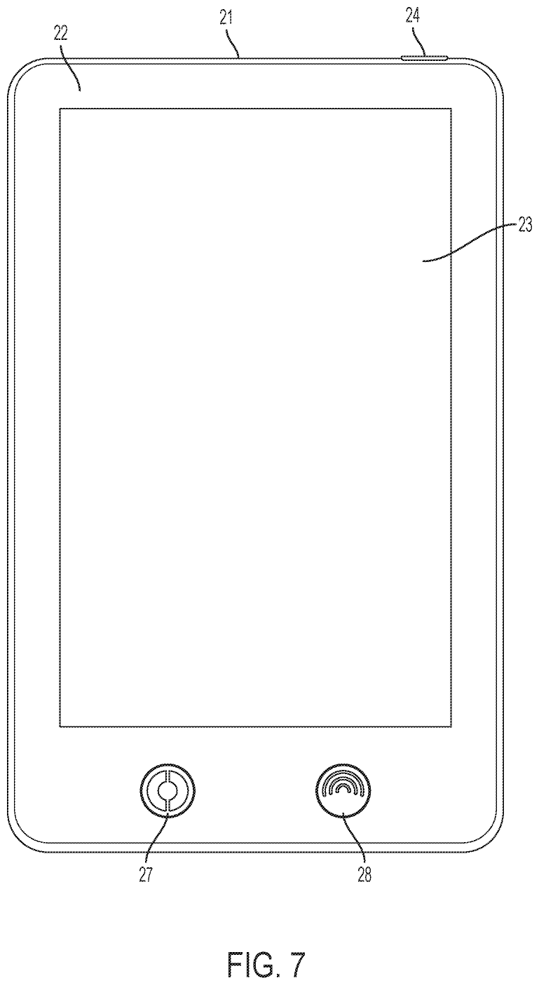

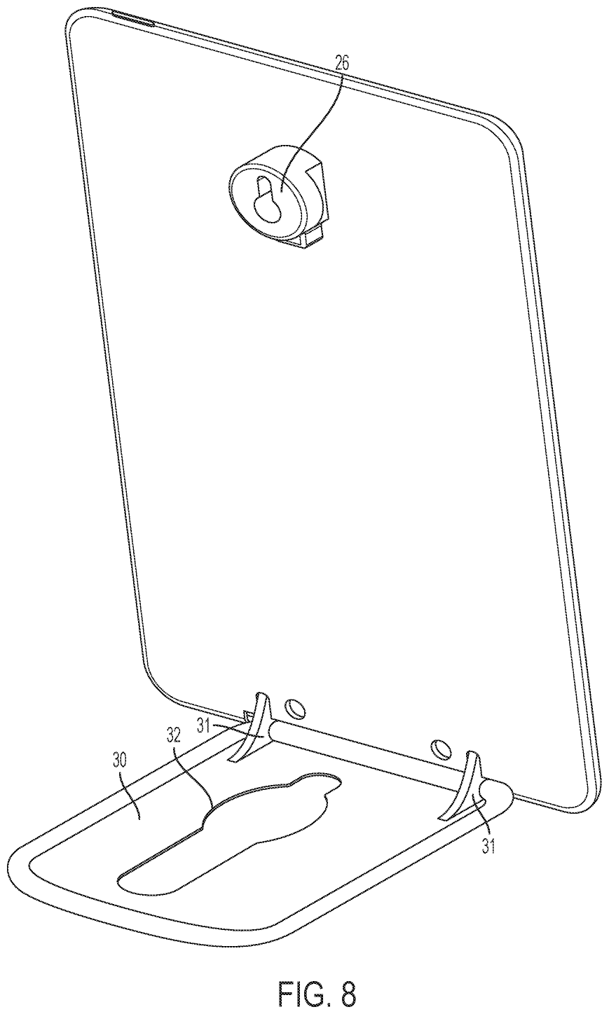

So that lamp 21 may stand upright during use, stand 30 is attachable to lamp 21, as shown in FIGS. 8-10. Stand 30 has extensions 31, which are attachable to case 22 via receptors 25. When lamp 21 is to be shipped, packed or otherwise stowed, stand 30 can be locked on protrusion 26, which extends from a back surface of case 22. Protrusion 26 is and cut-out portion 22 of stand 30 are sized such that they are engageable with one another, as shown in FIG. 7. Stand 30 can then be slid such that cut-out portion 22 and protrusion 26 are locked together. Protrusion 26 may also be configured to connect to a power cable.

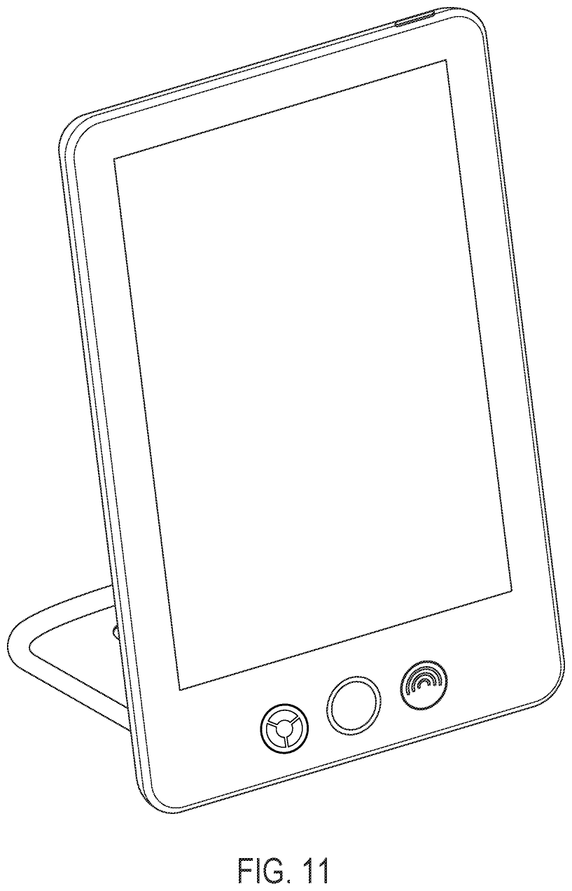

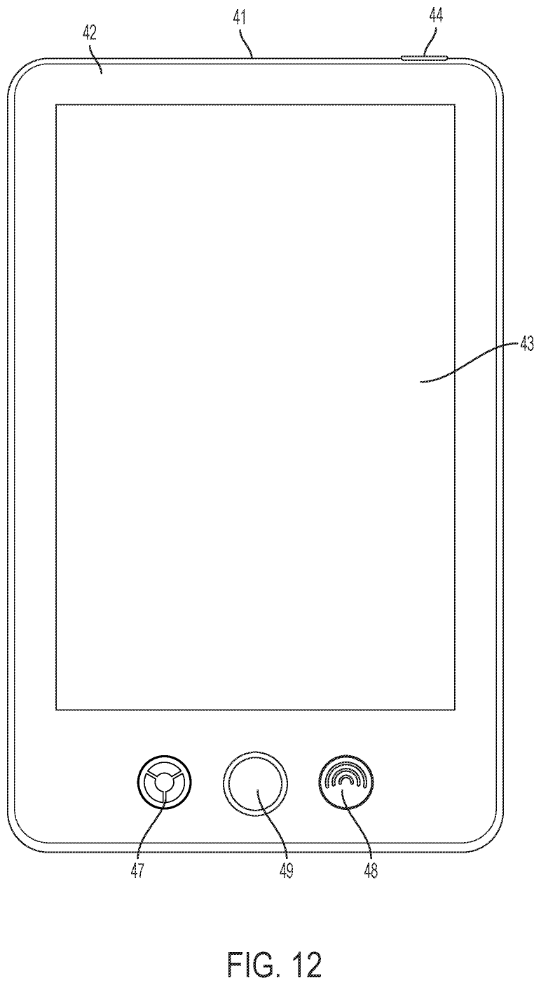

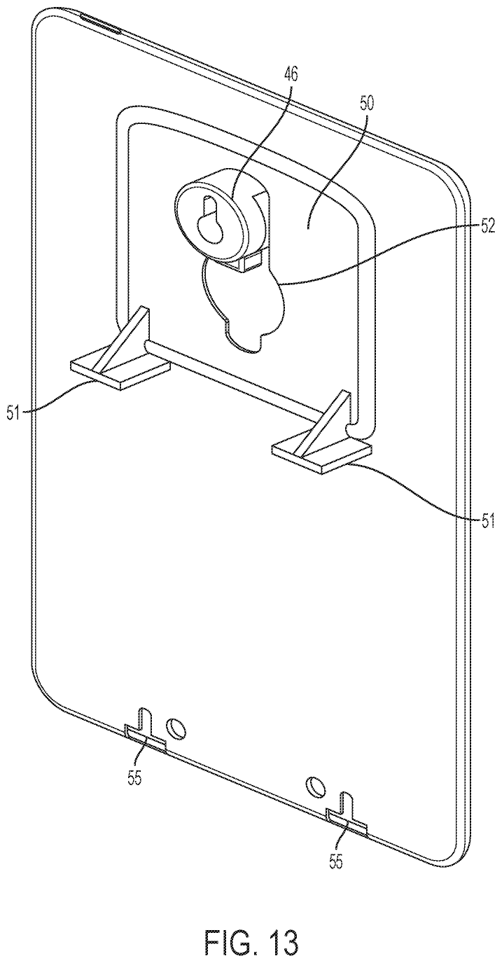

FIGS. 11-13 show lamp 41, with a case 42 that surrounds a light emitting surface 43. Lamp 41 may include a power button 44. Buttons 47, 48, and 49 may also be provided to perform functions of lamp 41. These functions can include, but are not limited to, increasing or decreasing brightness, modifying the emitted light temperature, and setting a usage timer. Buttons 47, 48, and 49 may cycle through predetermined settings for these functions or modify the functions at predetermined increments. The functions of the lamp may be programmable. Lamp 41 may include a controller for effectuating these functions. The controller may include circuitry, including analog and digital circuitry, a computer, including a microprocessor, FGPA, embedded controller, or the like.

For example, buttons 47, 48, or 49 may set lamp 21 to emit light at a brightness of 2,000-15,000 lux at a distance of 4-6 inches. In one preferred embodiment, buttons 47, 48, or 49 may be pressed to cycle emitted light between 2,500, 5,000, 7,500, or 10,000 lux. Buttons 47, 48, or 49 may also set the light temperature of the light emitted from lamp 21 between 3,000 K and 6,500 K. In one preferred embodiment, buttons 47, 48, or 49 may cycle light temperature levels between 3,000 K and 5,000 K in 500 K increments. Buttons 47, 48, or 49 may also set a usage timer for 5, 10, 20, or 30 minutes, after which the lamp may notify the user of the elapsed time, shut off, or both. In one preferred embodiment, the usage time is set for 20 minutes. In another embodiment, the countdown timer may be set in five minute increments up to one hour (sixty minutes). In another embodiment, the countdown timer may be in fifteen minute increments up to one hour (sixty minutes). The values for each of these functions are exemplary, as buttons 47, 48, or 49 may be programmed to set any value associated with any function.

In addition, buttons 47, 48, or 49 may set lamp 41 to emit light at a certain frequency. Standard light bulbs flicker at 100-120 Hz. LED light bulbs have a frequency of between 20 KHz and 32 KHz. Pressing buttons 27 or 28 may cause the light to emit light at different frequencies, including at 2 Hz-60 Hz, 100-120 Hz, or 20-32 Khz. In one embodiment, the frequency of the light is set to 40 Hz. When setting the light frequency to a particular frequency, such as 40 Hz, a usage timer may also be set automatically or using the other of buttons 27 and 28. In one embodiment the usage timer is set for 20 mins, and following its expiration, the frequency of the light is returned to another frequency, such as 100-120 Hz or 20-32 Khz. The light source may also emit light at multiple frequencies.

Lamp 41 may also include an indicator showing a progression of a function. The indicator may be a series of lights or a circular ring that is used to indicate the elapsed or remaining amount of time on a usage timer, the brightness level, the light temperature, or the light frequency. For example, circular ring 49 may show a 20-minute usage timer by illuminating neighboring portions of the circular ring after two-minute increments.

So that lamp 41 may stand upright during use, stand 50 is attachable to lamp 41, as shown in FIG. 11. Stand 50 has extensions 51, which are attachable to case 42 via receptors 45. When lamp 41 is to be shipped, packed or otherwise stowed, stand 50 can be locked on protrusion 46, which extends from a back surface of case 42. Protrusion 46 is and cut-out portion 42 of stand 50 are sized such that they are engageable with one another, as shown in FIG. 7. Stand 50 can then be slid such that cut-out portion 42 and protrusion 46 are locked together. Protrusion 46 may also be configured to connect to a power cable.

Lamps 1, 21, or 41 may use various types of light sources, including fluorescent, compact fluorescent, neodymium, and LED. LEDs may include various types of LEDs, including through-hole LEDs, SMD LEDs, bi-color LEDs, RGB LEDs, High-Power LEDs, and others. Light sources of different color temperatures may be used in order to dynamically change the output color temperature. For example, by selectively mixing an LED with a cool temperature of light and an LED with a warm temperature of light, any temperature of light may be emitted by lamps 1, 21, and 41. Buttons 27, 28, 47, 48, and 49 may control the temperature of the emitted light in this manner. The light source may be planar, cylindrical, or in a standard light-bulb shape.

Lamps 1, 21, or 41 may include a flush lens or a recessed lens. Lamps 1, 21, or 41 may also be edge-lit or back-lit. Back-lit lamps allow for the use of more LEDs (or other light sources) to control the output characteristics of the light. Edge-lit lamps provide the benefit of creating a more uniform and aesthetic light output.

Lamps 1, 21, or 41 may also include a wall-mount feature. The wall-mount feature may allow a user to quickly and easily remove it from the wall for travel purposes.

Lamps 1, 21, or 41 may also include a speaker. The speaker may emit sound at a certain frequency. The speaker may be integrated into the lamp 1, 21, or 41, or connectable to and/or controlled by the lamp. The speaker may emit sound at the frequency of the light emitted from the lamp. Alternatively, the speaker may emit sound at a frequency different from the frequency of the light emitted from the lamp. The speaker can also emit multiple frequencies of sound.

Lamps 1, 21, or 41 may also include a vibrating device. The vibrating device may vibrate at a certain frequency. The vibrating device may be a hand mitt, head band, wrist band, massage chair, or other type of vibrating device. The vibrating device may be integrated into the lamp 1, 21, or 41, or connectable to and/or controlled by the lamp. The vibrating device may vibrate at the frequency of the light emitted from the lamp. Alternatively, the vibrating device may vibrate at a frequency different from the frequency of the light emitted from the lamp. The vibrating device can also vibrate at multiple frequencies.

In some embodiments, lamps 1, 21, and 41 may have both a speaker and a vibrating device. The lamp, speaker, and vibrating device may all work at the same frequency, or different frequencies. Each of the lamp, speaker, and vibrating device's frequencies may be set by the user.

Although the invention has been described with reference to a particular arrangement of parts, features and the like, these are not intended to exhaust all possible arrangements or features, and indeed many other modifications and variations will be ascertainable to those of skill in the art.

1. A lamp comprising:
a light source for emitting light at a first frequency or a second frequency;
a stand having a plate and a first connector, and being connectable to the lamp in a standing position and in a stowing position;
wherein in the standing position, the first connector is connected to a second connector of the lamp and the plate is disconnected from the protrusion;
wherein in the stowing position, the plate is connected to a protrusion of the lamp and the first connector is disconnected from the second connector; and
wherein after having emitted light at the first frequency for a predetermined time, the light source emits light at the second frequency.

2. The lamp of claim 1, wherein the first connector is a clip and the second connector is a recess.

3. The lamp of claim 1, wherein the lamp has a third connector, wherein the stand is connectable to the lamp is a second standing position in which the first connector is connected to the third connector.

4. The lamp of claim 1, wherein the plate has a cutout for connecting to the protrusion.

5. The lamp of claim 1, wherein the protrusion has an opening for inserting a cable.

6. The lamp of claim 1, wherein the lamp has a button for controlling a function of the lamp.

7. The lamp of claim 6, wherein the function is a timer.

8. The lamp of claim 6, wherein the function modifies a color temperature of the emitted light.

9. The lamp of claim 6, wherein the function modifies a light intensity of the emitted light.

10. The lamp of claim 6, wherein the function causes the light source to emit light at either the first frequency or the second frequency.

11. The lamp of claim 15, wherein the function also causes a timer to be set.

12. The lamp of claim 6, wherein the lamp has an indicator for displaying a metric associated with the function of the lamp.

13. The lamp of claim 1, wherein the light source is a LED.

14. The lamp of claim 1, wherein the lamp is edge lit.

15. The lamp of claim 1, wherein the light source emits light at a frequency of 40 Hz for 20 minutes, after which the light source emits light at a different frequency.

16. The lamp of claim 1, wherein the light source is planar.

17. The lamp of claim 1, further comprising a speaker for emitting sound.

18. The lamp of claim 1, further comprising a vibrating device.

19. A lamp comprising a light source that emits light at a frequency of 40 Hz for 20 minutes, after which the light source emits light at a different frequency.

20. (canceled)
